(19) United States
(12) Patent Application Publication
(10) Pub. No.: US 2023/0119446 A1
(43) Pub. Date: Apr. 20, 2023

(54) CONFIGURING SIDELINK TRANSMISSION CONFIGURATION INDICATION STATE USING ACCESS LINK SIGNALING

(71) Applicant: QUALCOMM Incorporated, San Diego, CA (US)

(72) Inventors: Hua WANG, Basking Ridge, NJ (US); Sony AKKARAKARAN, Poway, CA (US); Tao LUO, San Diego, CA (US); Junyi LI, Fairless Hills, PA (US); Yan ZHOU, San Diego, CA (US); Hong CHENG, Basking Ridge, NJ (US); Jelena DAMNJANOVIC, Del Mar, CA (US); Peter GAAL, San Diego, CA (US); Jung Ho RYU, Fort Lee, NJ (US)

(21) Appl. No.: 17/451,205

(22) Filed: Oct. 18, 2021

(51) Int. Cl. H04W 72/02; H04W 76/20; H04W 76/30; H04W 72/04

(52) U.S. Cl. CPC H04W 72/02; H04W 76/20; H04W 76/30; H04W 72/0406

(57) ABSTRACT

Various aspects of the present disclosure generally relate to wireless communication. In some aspects, a base station may transmit, and a user equipment (UE) may receive, radio resource control (RRC) signaling configuring a list of sidelink transmission configuration indication (TCI) states. The UE may communicate on one or more sidelink channels using one or more sidelink TCI states included in the list of sidelink TCI states configured in the RRC signaling. Numerous other aspects are described.

### FIELD OF THE DISCLOSURE

Aspects of the present disclosure generally relate to wireless communication and to techniques and apparatuses for configuring sidelink transmission configuration indication (TCI) states using access link signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a base station, radio resource control (RRC) signaling configuring a list of sidelink transmission configuration indication (TCI) states. The method may include communicating on one or more sidelink channels using one or more sidelink TCI states included in the list of sidelink TCI states configured in the RRC signaling.

Some aspects described herein relate to a method of wireless communication performed by a base station. The method may include determining a list of sidelink TCI states to configure for a UE. The method may include transmitting, to the UE, RRC signaling configuring the list of sidelink TCI states.

Some aspects described herein relate to a UE for wireless communication. The user equipment may include a memory and one or more processors coupled to the memory. The one or more processors may be configured to receive, from a base station, RRC signaling configuring a list of sidelink TCI states. The one or more processors may be configured to communicate on one or more sidelink channels using one or more sidelink TCI states included in the list of sidelink TCI states configured in the RRC signaling.

Some aspects described herein relate to a base station for wireless communication. The base station may include a memory and one or more processors coupled to the memory. The one or more processors may be configured to determine a list of sidelink TCI states to configure for a UE. The one or more processors may be configured to transmit, to the UE, RRC signaling configuring the list of sidelink TCI states.

Some aspects described herein relate to a non-transitory computer-readable medium that stores a set of instructions for wireless communication by a UE. The set of instructions, when executed by one or more processors of the UE, may cause the UE to receive, from a base station, RRC signaling configuring a list of sidelink TCI states. The set of instructions, when executed by one or more processors of the UE, may cause the UE to communicate on one or more sidelink channels using one or more sidelink TCI states included in the list of sidelink TCI states configured in the RRC signaling.

Some aspects described herein relate to a non-transitory computer-readable medium that stores a set of instructions for wireless communication by a base station. The set of instructions, when executed by one or more processors of the base station, may cause the base station to determine a list of sidelink TCI states to configure for a UE. The set of instructions, when executed by one or more processors of the base station, may cause the base station to transmit, to the UE, RRC signaling configuring the list of sidelink TCI states.

Some aspects described herein relate to an apparatus for wireless communication. The apparatus may include means for receiving, from a base station, RRC signaling configuring a list of sidelink TCI states. The apparatus may include means for communicating on one or more sidelink channels using one or more sidelink TCI states included in the list of sidelink TCI states configured in the RRC signaling.

Some aspects described herein relate to an apparatus for wireless communication. The apparatus may include means for determining a list of sidelink TCI states to configure for a UE. The apparatus may include means for transmitting, to the UE, RRC signaling configuring the list of sidelink TCI states.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of access link communications and sidelink communications, in accordance with the present disclosure.

FIG. 5 is a diagram illustrating an example of using beams for access link communications between a base station and a UE, in accordance with the present disclosure.

FIGS. 6A-6B are diagrams illustrating examples of beam indications for access link and sidelink communications, in accordance with the present disclosure.

FIGS. 7A-7B are diagrams illustrating an example associated with configuring sidelink transmission configuration indication (TCI) states using access link signaling, in accordance with the present disclosure.

FIGS. 8-9 are diagrams illustrating example processes associated with configuring sidelink TCI states using access link signaling, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

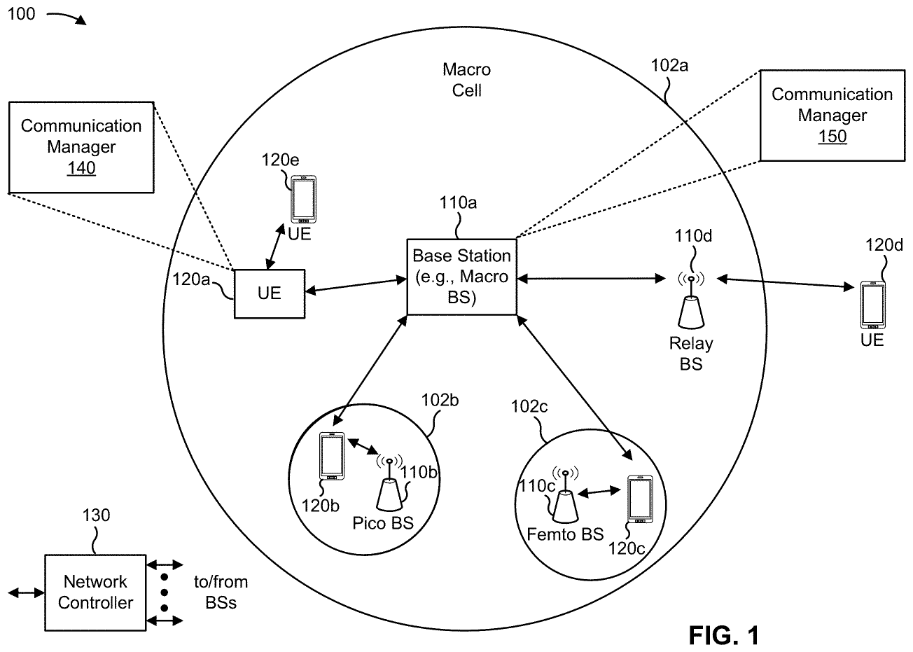

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station 110, radio resource control (RRC) signaling configuring a list of sidelink transmission configuration indication (TCI) states; and communicate on one or more sidelink channels using one or more sidelink TCI states included in the list of sidelink TCI states configured in the RRC signaling. Additionally, or alternatively, the communication manager 140 may perform one or more other operations described herein.

In some aspects, the base station 110 may include a communication manager 150. As described in more detail elsewhere herein, the communication manager 150 may determine a list of sidelink TCI states to configure for a UE 120; and transmit, to the UE, RRC signaling configuring the list of sidelink TCI states. Additionally, or alternatively, the communication manager 150 may perform one or more other operations described herein.

As indicated above, FIG. 1 is provided as an example. Other examples may differ from what is described with regard to FIG. 1.

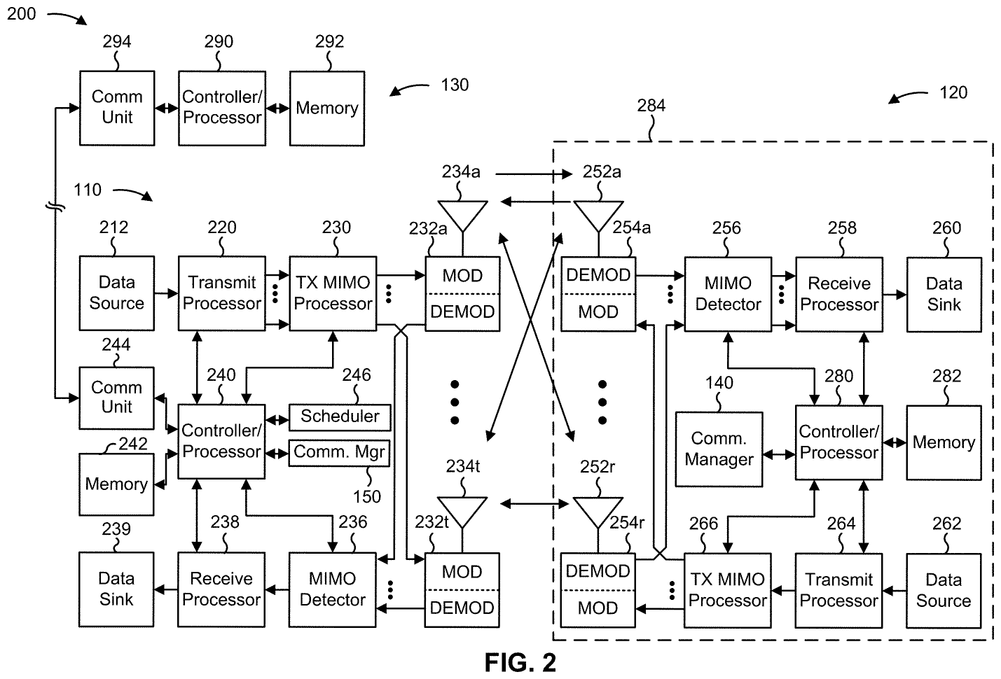

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

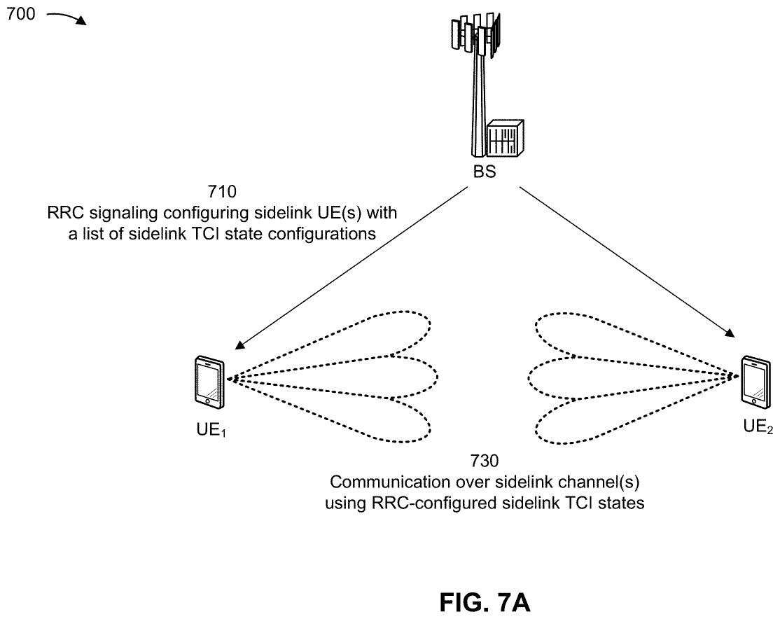

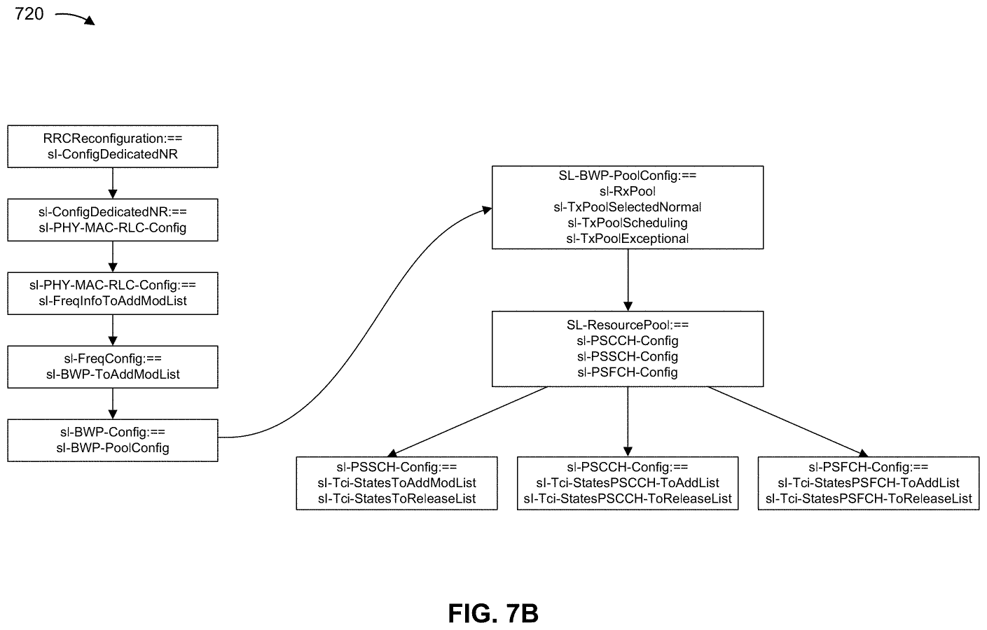

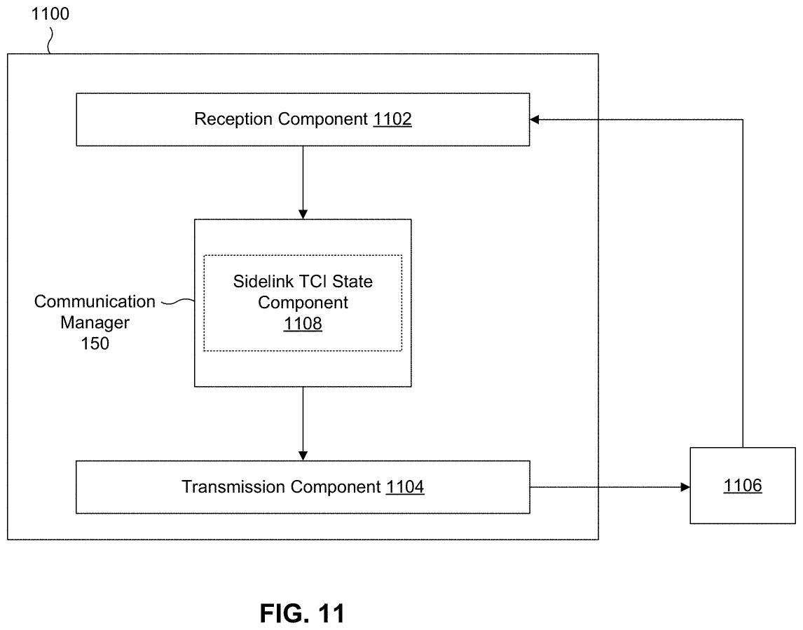

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-7B, FIG. 8, FIG. 9, FIG. 10, and/or FIG. 11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-7B, FIG. 8, FIG. 9, FIG. 10, and/or FIG. 11).

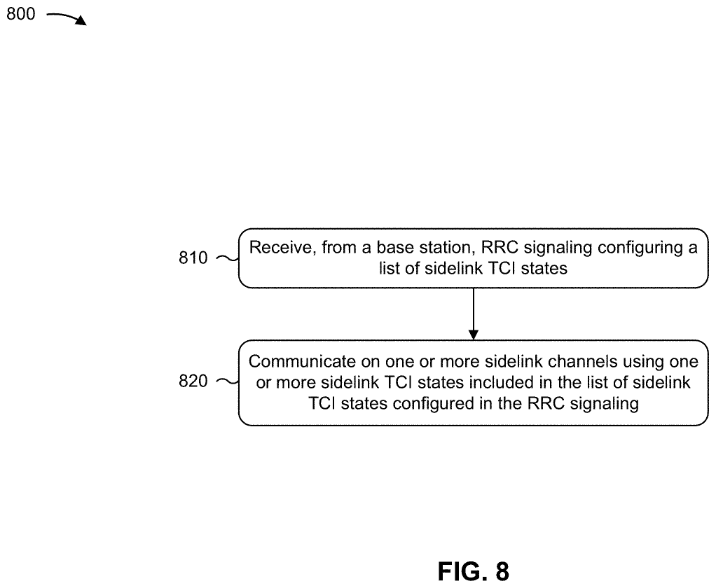

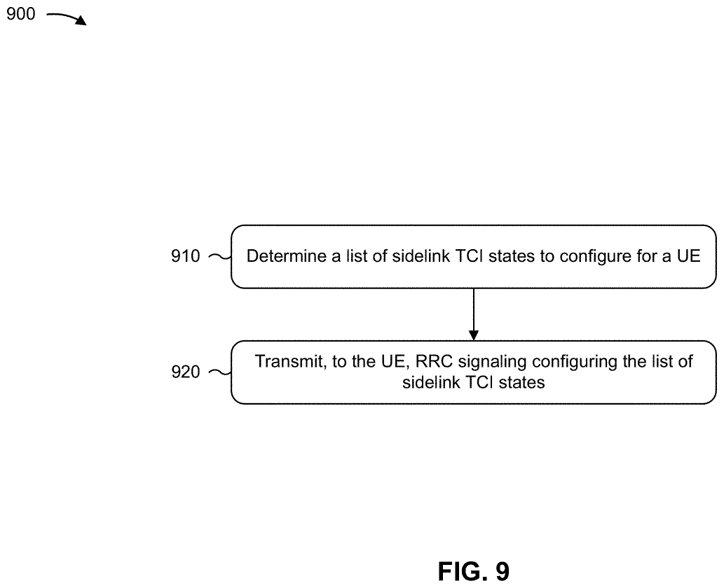

The controller/processor 240 of the base station 110, the controller/processor 280 of the UE 120, and/or any other component(s) of FIG. 2 may perform one or more techniques associated with configuring sidelink TCI states using access link signaling, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from the base station 110, RRC signaling configuring a list of sidelink TCI states (e.g., using antenna 252, modem 254, MIMO detector 256, receive processor 258, controller/processor 280, memory 282, or the like); and/or means for communicating on one or more sidelink channels using one or more sidelink TCI states included in the list of sidelink TCI states configured in the RRC signaling (e.g., using antenna 252, modem 254, MIMO detector 256, receive processor 258, transmit processor 264, TX MIMO processor 266, controller/processor 280, memory 282, or the like). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for determining a list of sidelink TCI states to configure for a UE 120 (e.g., using controller/processor 240, memory 242, or the like); and/or means for transmitting, to the UE 120, RRC signaling configuring the list of sidelink TCI states (e.g., using controller/processor 240, transmit processor 220, TX MIMO processor 230, MOD 232, antenna 234, memory 242, or the like). The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

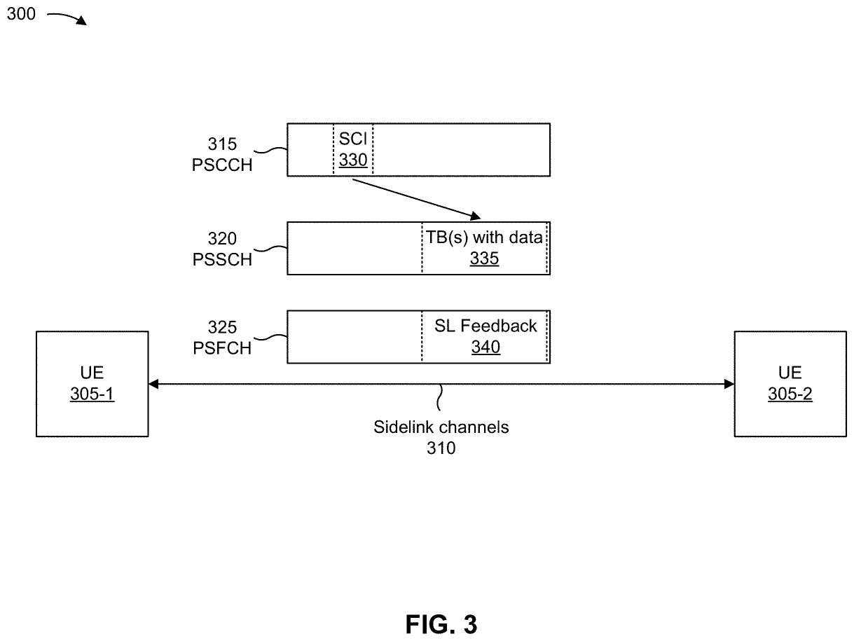

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARD) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 rather than a base station 110 (e.g., transmission mode 2, where a transmitting UE 305 self-selects transmission resources according to rules designed to minimize collision risk). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305 (e.g., transmission mode 2), the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

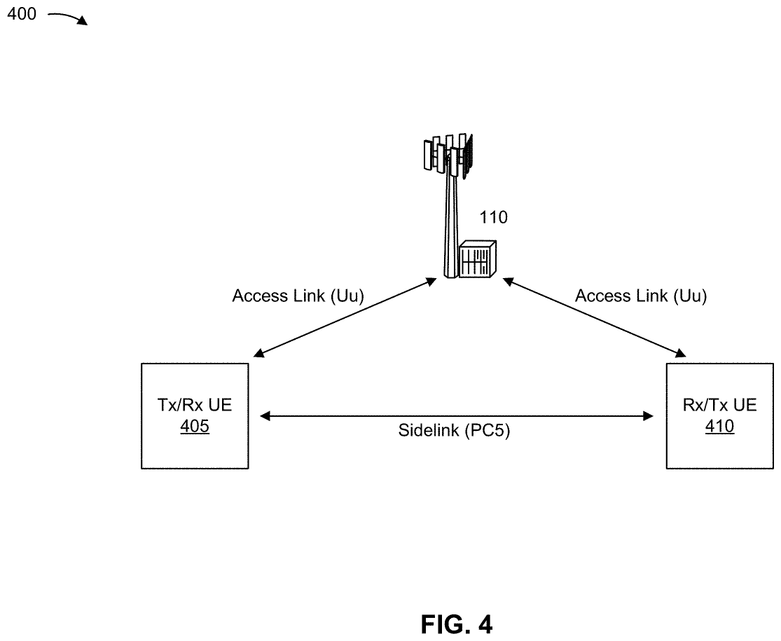

FIG. 4 is a diagram illustrating an example 400 of access link communications and sidelink communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link (e.g., in transmission mode 1, where the base station 110 indicates transmission resources to be used by the Tx/Rx UE 405). Additionally, or alternatively, in some sidelink modes (e.g., transmission mode 1), the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110). For example, as described in further detail herein, a downlink communication sent from a base station 110 to a UE 120 (e.g., the Tx/Rx UE 405 and/or the Rx/Tx UE 410) may include RRC signaling to configure one or more sidelink TCI states that the UE 120 is to use for sidelink communications (e.g., on a PSCCH, PSSCH, and/or PSFCH).

As indicated above, FIG. 4 is provided as an example. Other examples may differ from what is described with respect to FIG. 4.

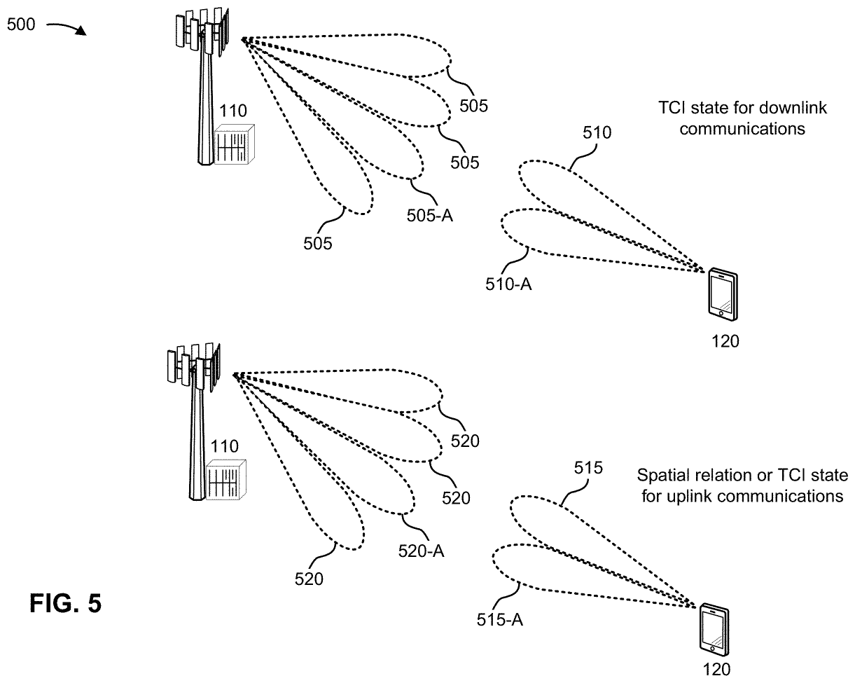

FIG. 5 is a diagram illustrating an example 500 of using beams for access link communications between a base station and a UE, in accordance with the present disclosure. As shown in FIG. 5, a base station 110 and a UE 120 may communicate with one another in a wireless network (e.g., wireless network 100).

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 505.

The UE 120 may attempt to receive downlink transmissions via one or more UE receive beams 510, which may be configured using different beamforming parameters at receive circuitry of the UE 120. The UE 120 may identify a particular BS transmit beam 505, shown as BS transmit beam 505-A, and a particular UE receive beam 510, shown as UE receive beam 510-A, that provide relatively favorable performance (e.g., that have a best channel quality of the different measured combinations of BS transmit beams 505 and UE receive beams 510). In some examples, the UE 120 may transmit an indication of which BS transmit beam 505 is identified by the UE 120 as a preferred BS transmit beam, which the base station 110 may select for transmissions to the UE 120. The UE 120 may thus attain and maintain a beam pair link (BPL) with the base station 110 for downlink communications (e.g., a combination of the BS transmit beam 505-A and the UE receive beam 510-A), which may be further refined and maintained in accordance with one or more established beam refinement procedures.

A downlink beam, such as a BS transmit beam 505 or a UE receive beam 510, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each BS transmit beam 505 may be associated with a synchronization signal block (SSB), and the UE 120 may indicate a preferred BS transmit beam 505 by transmitting uplink transmissions in resources of the SSB that are associated with the preferred BS transmit beam 505. A particular SSB may have an associated TCI state (e.g., for an antenna port or for beamforming). The base station 110 may, in some examples, indicate a downlink BS transmit beam 505 based at least in part on antenna port QCL properties that may be indicated by the TCI state. A TCI state may be associated with one downlink reference signal set (e.g., an SSB and an aperiodic, periodic, or semi-persistent channel state information reference signal (CSI-RS)) for different QCL types (e.g., QCL types for different combinations of Doppler shift, Doppler spread, average delay, delay spread, or spatial receive parameters, among other examples). In cases where the QCL type indicates spatial receive parameters (e.g., QCL type D), the QCL type may correspond to analog receive beamforming parameters of a UE receive beam 510 at the UE 120. Thus, the UE 120 may select a corresponding UE receive beam 510 from a set of BPLs based at least in part on the base station 110 indicating a BS transmit beam 505 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (e.g., activated PDSCH TCI states and activated CORESET TCI states) for the UE 120 may be configured by a configuration message, such as an RRC message (e.g., an RRCReconfiguration message).

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 515.

The base station 110 may receive uplink transmissions via one or more BS receive beams 520. The base station 110 may identify a particular UE transmit beam 515, shown as UE transmit beam 515-A, and a particular BS receive beam 520, shown as BS receive beam 520-A, that provide relatively favorable performance (e.g., that have a best channel quality of the different measured combinations of UE transmit beams 515 and BS receive beams 520). In some examples, the base station 110 may transmit an indication of which UE transmit beam 515 is identified by the base station 110 as a preferred UE transmit beam, which the base station 110 may select for transmissions from the UE 120. The UE 120 and the base station 110 may thus attain and maintain a BPL for uplink communications (e.g., a combination of the UE transmit beam 515-A and the BS receive beam 520-A), which may be further refined and maintained in accordance with one or more established beam refinement procedures. An uplink beam, such as a UE transmit beam 515 or a BS receive beam 520, may be associated with a spatial relation. A spatial relation may indicate a directionality or a characteristic of the uplink beam, similar to one or more QCL properties, as described above.

Additionally, or alternatively, as shown in FIG. 5, the base station 110 and the UE 120 may communicate using a unified TCI framework, in which case the base station 110 may indicate a TCI state that the UE 120 is to use for beamformed uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a PUSCH based on a dynamic grant or a configured grant or one or more dedicated PUCCH resources in a component carrier.

Additionally, or alternatively, the unified TCI framework may support a separate downlink TCI state and a separate uplink TCI state to accommodate separate downlink and uplink beam indications (e.g., in cases where a best uplink beam does not correspond to a best downlink beam, or vice versa). In such cases, each valid uplink TCI state configuration may contain a source reference signal to indicate an uplink transmit beam for a target uplink communication (e.g., a target uplink reference signal or a target uplink channel). For example, the source reference signal may be an sounding reference signal (SRS), an SSB, or a CSI-RS, among other examples, and the target uplink communication may be a physical random access channel (PRACH), a PUCCH, a PUSCH, an SRS, and/or a DMRS (e.g., for a PUCCH or a PUSCH), among other examples. In this way, supporting joint TCI states or separate downlink and uplink TCI states may enable a unified TCI framework for downlink and uplink communications and/or may enable the base station 110 to indicate various uplink QCL relationships (e.g., Doppler shift, Doppler spread, average delay, or delay spread, among other examples) for uplink TCI communication.

As indicated above, FIG. 5 is provided as an example. Other examples may differ from what is described with respect to FIG. 5.

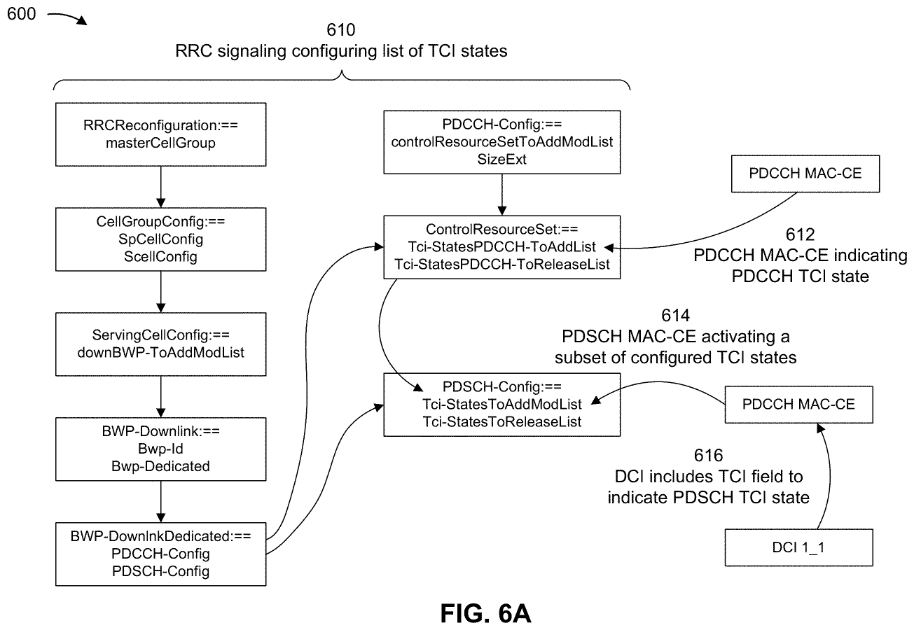

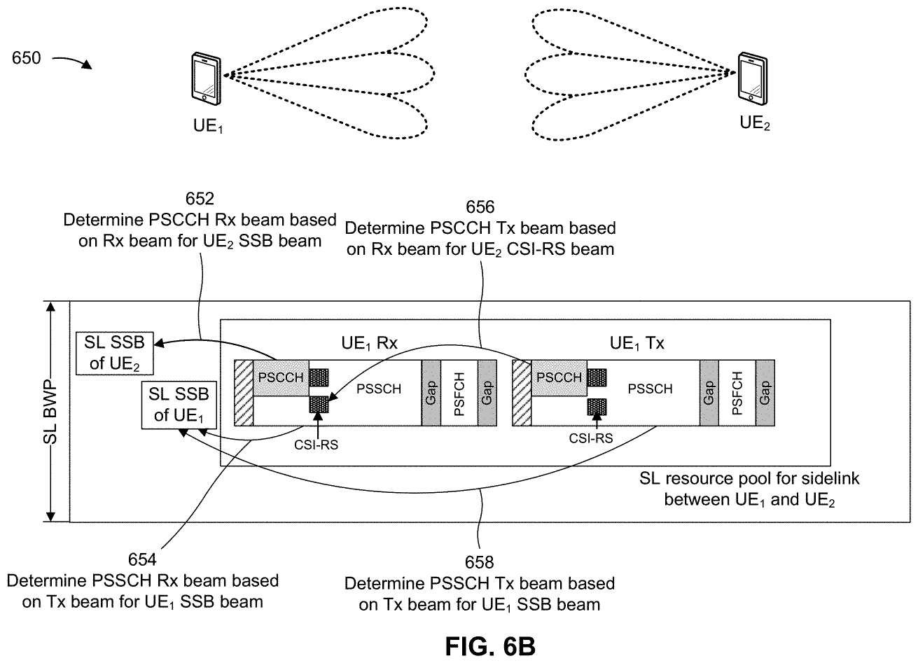

FIGS. 6A-6B are diagrams illustrating examples 600, 650 of beam indications for wireless communications, in accordance with the present disclosure. In particular, as described herein, FIG. 6A illustrates an example 600 of using a TCI state to provide a beam indication for access link communications, and FIG. 6B illustrates an example 650 of a beam indication that may be used for sidelink communications.

As shown in FIG. 6A, and by reference number 610, a base station may transmit RRC signaling to a UE in order to configure one or more TCI states to be used for beamformed communication. For example, FIG. 6A illustrates an example where the base station transmits an RRC reconfiguration message to a UE to configure a list of TCI states that may be used for downlink communication on a PDCCH and/or a PDSCH. Additionally, or alternatively, in cases where the base station and the UE are communicating in a wireless network that supports a unified TCI framework, the RRC configuration message may be used to configure one or more TCI states that can be used for a joint downlink and uplink beam indication and/or one or more TCI states that can be used for separate downlink and uplink beam indications. Accordingly, as described herein, the example 600 shown in FIG. 6A may be used to configure one or more TCI states for access link (e.g., downlink and/or uplink) communications.

For example, as shown by reference number 610, the RRC signaling may generally include an RRC reconfiguration message that carries a master cell group information element (IE), where the RRC reconfiguration message may be provided at a top level of an IE hierarchy in which each downstream IE is included in an upstream IE (e.g., a cell group configuration IE may be included in the master cell group IE, a serving cell configuration IE may be included in the cell group configuration IE, a downlink bandwidth part IE may be included in the serving cell configuration IE, and a dedicated downlink bandwidth part IE may be included in the downlink bandwidth part IE). As further shown in FIG. 6A, the dedicated downlink bandwidth part IE may include a PDCCH configuration and a PDSCH configuration, which may include one or more IEs to configure TCI states that the UE may use to receive PDCCH and PDSCH transmissions from the base station. For example, as shown, the PDSCH configuration may include a tci-StatesToAddModList parameter that indicates one or more TCI states to be added to a list of TCI states that are configured for PDSCH transmissions and/or a tci-StatesToReleaseList parameter that indicates one or more TCI states to be released (e.g., removed) from the list of TCI states configured for PDSCH transmissions. Furthermore, the PDCCH configuration may include a CORESET configuration in which a tci-StatesPDCCH-ToAddList parameter indicates a list of TCI state identifiers included in the list of TCI states configured for PDSCH transmissions that are also configured for PDCCH transmissions and further in which a tci-StatesPDCCH-ToReleaseList parameter indicates one or more TCI state identifiers that the UE is to release from the list of TCI states configured for PDCCH transmissions.

In general, as described herein, each TCI state that is configured for the UE may contain one or more parameters to configure a QCL relationship between one or two reference signals and one or more DMRS ports associated with a PDSCH, one or more DMRS ports associated with a PDCCH, or one or more CSI-RS ports associated with a CSI-RS resource. For example, the RRC reconfiguration message may include one or more parameters to indicate, for each TCI state in the list of TCI states that are configured for the UE, an identifier associated with the respective TCI state and a maximum of two (2) QCL types to indicate QCL information or QCL relationships per TCI state. For example, the RRC reconfiguration message may include a qcl-Type1 parameter to indicate a first QCL relationship for a first downlink reference signal (e.g., an SSB or a CSI-RS), and may optionally further include a qcl-Type2 parameter to indicate a second QCL relationship for a second downlink reference signal. Accordingly, as shown by reference number 612, the base station may indicate QCL information associated with a PDCCH transmission using a TCI state indication in a UE-specific PDCCH medium access control (MAC) control element (MAC-CE), where the TCI state indication in the PDCCH MAC-CE includes a TCI state identifier in the list of TCI state identifiers that are configured for PDCCH transmissions. Furthermore, as shown by reference number 614, the base station may activate a set of M TCI states (e.g., up to eight (8) or sixteen (16) TCI states) included in the list of TCI states that are configured for PDSCH transmissions using a UE-specific PDSCH MAC-CE. As shown by reference number 616, the base station may then use a TCI field in downlink control format (DCI) (e.g., DCI format 1_1) to indicate one of the M TCI states activated by the UE-specific PDSCH MAC-CE, whereby the UE uses the TCI state indicated in the TCI field of the DCI to receive a PDSCH transmission scheduled by the DCI.

As shown in FIG. 6B, and by example 650, beam indications used for sidelink communications between a first UE (shown as UE1) and a second UE (shown as UE2) may be based on a sidelink resource pool configured for a sidelink between the first UE and the second UE. For example, as shown, the sidelink resource pool may include time and frequency resources within a sidelink bandwidth part, where the sidelink resource pool includes respective sets of sidelink resources that the first UE and the second UE use to transmit a sidelink SSB. As further shown, the sidelink resource pool includes a first set of resources used when the first UE is receiving PSCCH, CSI-RS, PSSCH, and/or PSFCH transmissions from the second UE (shown as UE1 Rx) and a second set of resources used when the first UE is transmitting PSCCH, CSI-RS, PSSCH, and/or PSFCH transmissions to the second UE (shown as UE1 Tx). In this case, as shown, a UE may determine one or more beams to be used to receive and/or transmit a PSCCH and/or PSSCH based on one or more beams used to receive and/or transmit a sidelink SSB and/or a sidelink CSI-RS. For example, as shown by reference number 652, a receive beam that the first UE uses to receive a PSCCH from the second UE may be the same as a receive beam that the first UE uses to receive a sidelink SSB from the second UE. As further shown by reference number 654, a receive beam that the first UE uses to receive a PSSCH from the second UE may be the same as a transmit beam that the first UE uses to transmit a sidelink SSB to the second UE. As further shown by reference number 656, a transmit beam that the first UE uses to transmit a PSCCH to the second UE may be the same as a receive beam that the first UE uses to receive a sidelink CSI-RS from the second UE. As further shown by reference number 658, a transmit beam that the first UE uses to transmit a PSSCH to the second UE may be the same as the transmit beam that the first UE uses to transmit the sidelink SSB to the second UE.

Accordingly, as described herein, a beam indication for access link communications (e.g., for downlink communications, or for downlink and uplink communications in a unified TCI framework) may be based on a TCI state that indicates one or more QCL relationships for a target channel based on properties associated with a downlink reference signal transmitted by a base station. However, sidelink communications between UEs is more symmetric than access link communications between a base station and a UE, whereby a reference signal may be transmitted by either UE. Sidelink beams indications may therefore use different techniques to specify QCL relationships for beams that are used to receive or transmit a sidelink channel (e.g., a PSCCH, PSSCH, or PSFCH) depending on a target sidelink channel and which signal is used as a source reference signal for the target sidelink channel. However, because there are no TCI states defined for sidelink communications in current standards, a base station that configures two UEs to communicate on a sidelink may be unable to signal the QCL relationships that define the sidelink beam indications. Accordingly, some aspects described herein relate to techniques and apparatuses to extend the TCI framework used to provide access link beam indications to sidelink beams.

As indicated above, FIGS. 6A-6B are provided as examples. Other examples may differ from what is described with respect to FIGS. 6A-6B.

FIGS. 7A-7B are diagrams illustrating an example 700 associated with configuring sidelink TCI states using access link signaling, in accordance with the present disclosure. As shown in FIG. 7A, example 700 includes a first UE (shown as UE1) and a second UE (shown as UE2) that may communicate via a wireless sidelink and a base station that may communicate with one or more of the first UE or the second UE via a wireless access link, which may include an uplink and a downlink. In some aspects, the base station and the UEs may be included in a wireless network, such as wireless network 100, and may communicate using unicast sidelink communications according to a first resource allocation mode (e.g., transmission mode 1) in which the base station performs sidelink resource selection and scheduling (e.g., when the transmitting UE is in an RRC connected state). Additionally, or alternatively, the first UE and the second UE may communicate on the sidelink using a second resource allocation mode (e.g., transmission mode 2) in which a transmitting UE autonomously performs sidelink resource selection and scheduling (e.g., when the transmitting UE is in an RRC idle state or outside a coverage area associated with the base station).

As shown in FIG. 7A, and by reference number 710, the base station may transmit, and the first UE may receive, RRC signaling that configures the first UE with a list of sidelink TCI state configurations that the first UE is to use for unicast sidelink communications. Although some aspects are described herein in a context where the base station transmits RRC signaling to configure the first UE with a list of sidelink TCI state configurations, the same or similar techniques may be used to configure the second UE (or any other UE) with a list of sidelink TCI state configurations to be used for sidelink communications. In general, as described herein, each sidelink TCI state in the list of sidelink TCI state configurations may include a sidelink TCI state identifier (e.g., an sl-Tci-StateId) and either one or two QCL types define QCL relationships or QCL information for the associated with sidelink TCI state. For example, one sidelink TCI state may include up to two QCL types, each of which includes one or more parameters to indicate one or more properties of a source reference signal that can be used to derive the QCL properties for a sidelink signal that is transmitted using the associated sidelink TCI state. For example, the QCL information associated with a sidelink TCI state may include, among other fields or IEs, a parameter to indicate a set of most significant bits of a Layer-2 identifier for a UE sending the reference signal that is QCLed with a signal transmitted using the corresponding sidelink TCI state. In another example, the QCL information associated with a sidelink TCI state may include a one-bit Tx/Rx field, which may have a first value (e.g., one (1)) to indicate that the QCLed source reference signal is transmitted by the UE receiving the RRC signaling that configures the list of sidelink TCI states or a second value (e.g., zero (0)) to indicate that the QCLed source reference signal is transmitted by another UE. Alternatively, in cases where the QCLed source reference signal is always a received reference signal, the QCL information associated with a sidelink TCI state may have the same format as the QCL information associated with an access link TCI state (e.g., indicating a serving cell index, bandwidth part identifier, a sidelink CSI-RS resource identifier or a sidelink SSB index corresponding to the source reference signal, and a QCL type that indicates a combination of Doppler shift, Doppler spread, average delay, delay spread, and/or spatial receive parameters that can be derived from the source reference signal).

In some aspects, as described herein, the base station may indicate the list of sidelink TCI state configurations in access link RRC signaling, such as an RRC reconfiguration message, and the list of sidelink TCI state configurations may provide a common TCI state pool that the first UE is to use for all sidelinks. For example, in cases where the first UE communicates with the second UE on a first sidelink and with one or more additional UEs (not shown) on other sidelinks, the list of sidelink TCI state configurations may be used for the first sidelink and for the other sidelinks. Alternatively, in some aspects, sidelink TCI state configurations for different sidelinks may be provided in different TCI state pools. For example, in cases where the first UE communicates with multiple UEs on different sidelinks, the RRC signaling may configure a first list of TCI state configurations for a first sidelink, a second list of TCI state configurations for a second sidelink, and so on.

In some aspects, as described above, the base station may indicate the list of sidelink TCI state configurations in access link RRC signaling, such as an RRC reconfiguration message. For example, FIG. 6B illustrates an example structure 720 for the RRC reconfiguration message that used to configure a list of sidelink TCI states. For example, as shown, the RRC reconfiguration message may include various hierarchical IEs to indicate a sidelink resource pool configuration (e.g., an SL-ResourcePool) for a particular sidelink bandwidth part. As shown, the sidelink resource pool configuration may include a PSCCH configuration, a PSSCH configuration, and a PSFCH configuration. Accordingly, in some aspects, the RRC reconfiguration message may configure the list of sidelink TCI states using a first parameter (e.g., sl-Tci-StatesToAddModList) that indicates one or more sidelink TCI states to be added to the list of sidelink TCI states that are configured for the PSSCH and/or a second parameter (e.g., sl-Tci-StatesToReleaseList) that indicates one or more sidelink TCI states to be released from the list of sidelink TCI states that are configured for the PSSCH.

Accordingly, as further shown, the RRC reconfiguration message may indicate a PSCCH configuration according to a first parameter (e.g., sl-Tci-StatesPSCCH-ToAddList) that indicates, of the list of sidelink TCI states configured for the PSSCH, one or more sidelink TCI state identifiers to be added to a list of sidelink TCI states that are configured for the PSCCH and/or a second parameter (e.g., sl-Tci-StatesPSCCH-ToReleaseList) that indicates, of the list of sidelink TCI states configured for the PSSCH, one or more sidelink TCI state identifiers to be released from the list of sidelink TCI states that are configured for the PSCCH. Similarly, the RRC reconfiguration message may indicate a PSFCH configuration according to a first parameter (e.g., sl-Tci-StatesPSFCH-ToAddList) that indicates, of the list of sidelink TCI states configured for the PSSCH, one or more sidelink TCI state identifiers to be added to a list of sidelink TCI states that are configured for the PSFCH and/or a second parameter (e.g., sl-Tci-StatesPSFCH-ToReleaseList) that indicates, of the list of sidelink TCI states configured for the PSSCH, one or more sidelink TCI state identifiers to be released from the list of sidelink TCI states that are configured for the PSFCH. Accordingly, the sidelink TCI states to be used for a PSxCH (e.g., a PSSCH, PSCCH, or PSFCH) may be indicated in the sidelink resource pool configuration IE of the RRC reconfiguration message. Additionally, or alternatively, in cases where the sidelink resource pool includes a time gap between a PSCCH and a PSSCH, separate lists of sidelink TCI states may be configured for the PSCCH and the PSSCH, and sidelink TCI states used for a PSFCH may be a subset of the list of sidelink TCI states configured for the PSCCH or the list of sidelink TCI states configured for the PSSCH.

Referring again to FIG. 7A, as shown by reference number 730, the first UE may communicate with the second UE (and/or one or more other UEs) over a sidelink channel using a sidelink TCI state included in the list of sidelink TCI states configured by the RRC signaling. For example, in some aspects, the first UE may be configured to receive or transmit a PSCCH, a PSSCH, or a PSFCH, and may select a beam to use to receive or transmit the PSCCH, the PSSCH, or the PSFCH based on a sidelink TCI state that is selected for the sidelink communication. For example, in transmission mode 1, the base station may transmit, to a transmitting UE, DCI that includes a sidelink TCI state indication to indicate a sidelink TCI state to be used to transmit a PSCCH, a PSSCH, and/or a PSFCH, and the transmitting UE may transmit SCI to the receiving UE to indicate the sidelink TCI state to be used to receive the PSCCH, PSSCH, and/or PSFCH. Additionally, or alternatively, in transmission mode 2, the transmitting UE may autonomously select, based on the RRC-configured list of sidelink TCI states, a sidelink TCI state to be used to transmit a PSCCH, a PSSCH, and/or a PSFCH, and the transmitting UE may transmit SCI to the receiving UE to indicate the sidelink TCI state to be used to receive the PSCCH, PSSCH, and/or PSFCH.

As indicated above, FIGS. 7A-7B are provided as examples. Other examples may differ from what is described with respect to FIGS. 7A-7B.

FIG. 8 is a diagram illustrating an example process 800 performed, for example, by a UE, in accordance with the present disclosure. Example process 800 is an example where the UE (e.g., UE 120, UE 305, Tx/Rx UE 405, and/or Rx/Tx UE 410) performs operations associated with configuring sidelink TCI states using access link signaling.

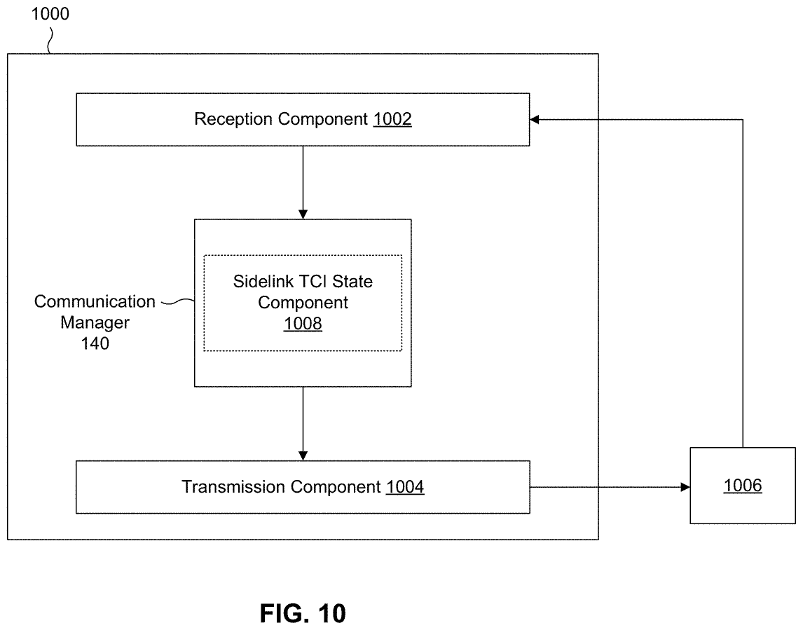

As shown in FIG. 8, in some aspects, process 800 may include receiving, from a base station, RRC signaling configuring a list of sidelink TCI states (block 810). For example, the UE (e.g., using communication manager 140 and/or reception component 1002, depicted in FIG. 10) may receive, from a base station, RRC signaling configuring a list of sidelink TCI states, as described above with reference to FIGS. 7A-7B.

As further shown in FIG. 8, in some aspects, process 800 may include communicating on one or more sidelink channels using one or more sidelink TCI states included in the list of sidelink TCI states configured in the RRC signaling (block 820). For example, the UE (e.g., using communication manager 140 and/or sidelink TCI state component 1008, depicted in FIG. 10) may communicate on one or more sidelink channels using one or more sidelink TCI states included in the list of sidelink TCI states configured in the RRC signaling, as described above with reference to FIGS. 7A-7B.

Process 800 may include additional aspects, such as any single aspect or any combination of aspects described below and/or in connection with one or more other processes described elsewhere herein.

In a first aspect, the list of sidelink TCI states includes a common TCI state pool for all sidelinks.

In a second aspect, alone or in combination with the first aspect, the list of sidelink TCI states includes at least a first TCI state pool for a first sidelink and a second TCI state pool for a second sidelink.

In a third aspect, alone or in combination with one or more of the first and second aspects, the RRC signaling indicates sidelink QCL information associated with each sidelink TCI state included in the list of sidelink TCI states.

In a fourth aspect, alone or in combination with one or more of the first through third aspects, the RRC signaling configures the list of sidelink TCI states for a PSSCH.

In a fifth aspect, alone or in combination with one or more of the first through fourth aspects, the RRC signaling indicates one or more sidelink TCI states to add to the list of sidelink TCI states configured for the PSSCH.

In a sixth aspect, alone or in combination with one or more of the first through fifth aspects, the RRC signaling indicates one or more sidelink TCI states to release from the list of sidelink TCI states configured for the PSSCH.

In a seventh aspect, alone or in combination with one or more of the first through sixth aspects, the RRC signaling indicates, of the list of sidelink TCI states configured for the PSSCH, one or more sidelink TCI states to add to or release from a list of sidelink TCI states for one or more of a PSCCH or a PSFCH.

In an eighth aspect, alone or in combination with one or more of the first through seventh aspects, the RRC signaling configures the list of sidelink TCI states using one or more of a PSSCH configuration, a PSCCH configuration, or a PSFCH configuration included in a sidelink resource pool configuration.

In a ninth aspect, alone or in combination with one or more of the first through eighth aspects, the list of sidelink TCI states configured in the RRC signaling includes a first set of sidelink TCI states that are configured for a PSSCH and a second set of sidelink TCI states that are configured for a PSCCH.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with configuring sidelink TCI state using access link signaling.

As shown in FIG. 9, in some aspects, process 900 may include determining a list of sidelink TCI states to configure for a UE (block 910). For example, the base station (e.g., using communication manager 150 and/or sidelink TCI state component 1108, depicted in FIG. 11) may determine a list of sidelink TCI states to configure for a UE, as described above with reference to FIGS. 7A-7B.

As further shown in FIG. 9, in some aspects, process 900 may include transmitting, to the UE, RRC signaling configuring the list of sidelink TCI states (block 920). For example, the base station (e.g., using communication manager 150 and/or transmission component 1104, depicted in FIG. 11) may transmit, to the UE, RRC signaling configuring the list of sidelink TCI states, as described above with reference to FIGS. 7A-7B.

Process 900 may include additional aspects, such as any single aspect or any combination of aspects described below and/or in connection with one or more other processes described elsewhere herein.

In a first aspect, the list of sidelink TCI states includes a common TCI state pool for all sidelinks associated with the UE.

In a second aspect, alone or in combination with the first aspect, the list of sidelink TCI states includes at least a first TCI state pool for a first sidelink associated with the UE and a second TCI state pool for a second sidelink associated with the UE.

In a third aspect, alone or in combination with one or more of the first and second aspects, the RRC signaling indicates sidelink QCL information associated with each sidelink TCI state included in the list of sidelink TCI states.

In a fourth aspect, alone or in combination with one or more of the first through third aspects, the RRC signaling configures the list of sidelink TCI states for a PSSCH.

In a fifth aspect, alone or in combination with one or more of the first through fourth aspects, the RRC signaling indicates one or more sidelink TCI states to add to the list of sidelink TCI states configured for the PSSCH.

In a sixth aspect, alone or in combination with one or more of the first through fifth aspects, the RRC signaling indicates one or more sidelink TCI states to release from the list of sidelink TCI states configured for the PSSCH.

In a seventh aspect, alone or in combination with one or more of the first through sixth aspects, the RRC signaling indicates, of the list of sidelink TCI states configured for the PSSCH, one or more sidelink TCI states to add to or release from a list of sidelink TCI states for one or more of a PSCCH or a PSFCH.

In an eighth aspect, alone or in combination with one or more of the first through seventh aspects, the RRC signaling configures the list of sidelink TCI states using one or more of a PSSCH configuration, a PSCCH configuration, or a PSFCH configuration included in a sidelink resource pool configuration.

In a ninth aspect, alone or in combination with one or more of the first through eighth aspects, the list of sidelink TCI states configured in the RRC signaling includes a first set of sidelink TCI states that are configured for a PSSCH and a second set of sidelink TCI states that are configured for a PSCCH.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a sidelink TCI state component 1008, among other examples.

In some aspects, the apparatus 1000 may be configured to perform one or more operations described herein in connection with FIGS. 7A-7B. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a base station, RRC signaling configuring a list of sidelink TCI states. The sidelink TCI state component 1008 may communicate on one or more sidelink channels using one or more sidelink TCI states included in the list of sidelink TCI states configured in the RRC signaling.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a sidelink TCI state component 1108, among other examples.

In some aspects, the apparatus 1100 may be configured to perform one or more operations described herein in connection with FIGS. 7A-7B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The sidelink TCI state component 1108 may determine a list of sidelink TCI states to configure for a UE. The transmission component 1104 may transmit, to the UE, RRC signaling configuring the list of sidelink TCI states.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, from a base station, RRC signaling configuring a list of sidelink TCI states; and communicating on one or more sidelink channels using one or more sidelink TCI states included in the list of sidelink TCI states configured in the RRC signaling.

Aspect 2: The method of Aspect 1, wherein the list of sidelink TCI states includes a common TCI state pool for all sidelinks.

Aspect 3: The method of Aspect 1, wherein the list of sidelink TCI states includes at least a first TCI state pool for a first sidelink and a second TCI state pool for a second sidelink.

Aspect 4: The method of any of Aspects 1-3, wherein the RRC signaling indicates sidelink QCL information associated with each sidelink TCI state included in the list of sidelink TCI states.

Aspect 5: The method of any of Aspects 1-4, wherein the RRC signaling configures the list of sidelink TCI states for a PSSCH.

Aspect 6: The method of Aspect 5, wherein the RRC signaling indicates one or more sidelink TCI states to add to the list of sidelink TCI states configured for the PSSCH.

Aspect 7: The method of any of Aspects 5-6, wherein the RRC signaling indicates one or more sidelink TCI states to release from the list of sidelink TCI states configured for the PSSCH.

Aspect 8: The method of any of Aspects 5-7, wherein the RRC signaling indicates, of the list of sidelink TCI states configured for the PSSCH, one or more sidelink TCI states to add to or release from a list of sidelink TCI states for one or more of a PSCCH or a PSFCH.

Aspect 9: The method of any of Aspects 1-8, wherein the RRC signaling configures the list of sidelink TCI states using one or more of a PSSCH configuration, a PSCCH configuration, or a PSFCH configuration included in a sidelink resource pool configuration.

Aspect 10: The method of any of Aspects 1-9, wherein the list of sidelink TCI states configured in the RRC signaling includes a first set of sidelink TCI states that are configured for a PSSCH and a second set of sidelink TCI states that are configured for a PSCCH.

Aspect 11: A method of wireless communication performed by a base station, comprising: determining a list of sidelink TCI states to configure for a UE; and transmitting, to the UE, RRC signaling configuring the list of sidelink TCI states.

Aspect 12: The method of Aspect 11, wherein the list of sidelink TCI states includes a common TCI state pool for all sidelinks associated with the UE.

Aspect 13: The method of Aspect 11, wherein the list of sidelink TCI states includes at least a first TCI state pool for a first sidelink associated with the UE and a second TCI state pool for a second sidelink associated with the UE.

Aspect 14: The method of any of Aspects 11-13, wherein the RRC signaling indicates sidelink QCL information associated with each sidelink TCI state included in the list of sidelink TCI states.

Aspect 15: The method of any of Aspects 11-14, wherein the RRC signaling configures the list of sidelink TCI states for a PSSCH.

Aspect 16: The method of Aspect 15, wherein the RRC signaling indicates one or more sidelink TCI states to add to the list of sidelink TCI states configured for the PSSCH.

Aspect 17: The method of any of Aspects 15-16, wherein the RRC signaling indicates one or more sidelink TCI states to release from the list of sidelink TCI states configured for the PSSCH.

Aspect 18: The method of any of Aspects 15-17, wherein the RRC signaling indicates, of the list of sidelink TCI states configured for the PSSCH, one or more sidelink TCI states to add to or release from a list of sidelink TCI states for one or more of a PSCCH or a PSFCH.

Aspect 19: The method of any of Aspects 11-18, wherein the RRC signaling configures the list of sidelink TCI states using one or more of a PSSCH configuration, a PSCCH configuration, or a PSFCH configuration included in a sidelink resource pool configuration.

Aspect 20: The method of any of Aspects 11-19, wherein the list of sidelink TCI states configured in the RRC signaling includes a first set of sidelink TCI states that are configured for a PSSCH and a second set of sidelink TCI states that are configured for a PSCCH.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, radio resource control (RRC) signaling configuring a list of sidelink transmission configuration indication (TCI) states; and
communicate on one or more sidelink channels using one or more sidelink TCI states included in the list of sidelink TCI states configured in the RRC signaling.

2. The UE of claim 1, wherein the list of sidelink TCI states includes a common TCI state pool for all sidelinks.

3. The UE of claim 1, wherein the list of sidelink TCI states includes at least a first TCI state pool for a first sidelink and a second TCI state pool for a second sidelink.

4. The UE of claim 1, wherein the RRC signaling indicates sidelink quasi co-location information associated with each sidelink TCI state included in the list of sidelink TCI states.

5. The UE of claim 1, wherein the RRC signaling configures the list of sidelink TCI states for a physical sidelink shared channel (PSSCH).

6. The UE of claim 5, wherein the RRC signaling indicates one or more of:
one or more sidelink TCI states to add to the list of sidelink TCI states configured for the PSSCH,
one or more sidelink TCI states to release from the list of sidelink TCI states configured for the PSSCH, or
one or more sidelink TCI states, corresponding to sidelink TCI states from among the list of sidelink TCI states configured for the PSSCH, to add to or release from a list of sidelink TCI states for one or more of a physical sidelink control channel or a physical sidelink feedback channel.

7. The UE of claim 1, wherein the RRC signaling configures the list of sidelink TCI states using one or more of a physical sidelink shared channel configuration, a physical sidelink control channel configuration, or a physical sidelink feedback channel configuration included in a sidelink resource pool configuration.

8. The UE of claim 1, wherein the list of sidelink TCI states configured in the RRC signaling includes a first set of sidelink TCI states that are configured for a physical sidelink shared channel (PSSCH) and a second set of sidelink TCI states that are configured for a physical sidelink control channel (PSCCH).

9. A base station for wireless communication, comprising:
a memory; and
one or more processors, coupled to the memory, configured to:
determine a list of sidelink transmission configuration indication (TCI) states to configure for a user equipment (UE); and
transmit, to the UE, radio resource control (RRC) signaling configuring the list of sidelink TCI states.

10. The base station of claim 9, wherein the list of sidelink TCI states includes a common TCI state pool for all sidelinks associated with the UE.

11. The base station of claim 9, wherein the list of sidelink TCI states includes at least a first TCI state pool for a first sidelink associated with the UE and a second TCI state pool for a second sidelink associated with the UE.

12. The base station of claim 9, wherein the RRC signaling indicates sidelink quasi co-location information associated with each sidelink TCI state included in the list of sidelink TCI states.

13. The base station of claim 9, wherein the RRC signaling configures the list of sidelink TCI states for a physical sidelink shared channel (PSSCH).

14. The base station of claim 13, wherein the RRC signaling indicates one or more of:
one or more sidelink TCI states to add to the list of sidelink TCI states configured for the PSSCH,
one or more sidelink TCI states to release from the list of sidelink TCI states configured for the PSSCH, or
one or more sidelink TCI states, corresponding to sidelink TCI states from among the list of sidelink TCI states configured for the PSSCH, to add to or release from a list of sidelink TCI states for one or more of a physical sidelink control channel or a physical sidelink feedback channel.

15. The base station of claim 9, wherein the RRC signaling configures the list of sidelink TCI states using one or more of a physical sidelink shared channel configuration, a physical sidelink control channel configuration, or a physical sidelink feedback channel configuration included in a sidelink resource pool configuration.

16. The base station of claim 9, wherein the list of sidelink TCI states configured in the RRC signaling includes a first set of sidelink TCI states that are configured for a physical sidelink shared channel (PSSCH) and a second set of sidelink TCI states that are configured for a physical sidelink control channel (PSCCH).

17. A method of wireless communication performed by a user equipment (UE), comprising:
receiving, from a base station, radio resource control (RRC) signaling configuring a list of sidelink transmission configuration indication (TCI) states; and
communicating on one or more sidelink channels using one or more sidelink TCI states included in the list of sidelink TCI states configured in the RRC signaling.

18. The method of claim 17, wherein the list of sidelink TCI states includes a common TCI state pool for all sidelinks.

19. The method of claim 17, wherein the list of sidelink TCI states includes at least a first TCI state pool for a first sidelink and a second TCI state pool for a second sidelink.

20. The method of claim 17, wherein the RRC signaling indicates sidelink quasi co-location information associated with each sidelink TCI state included in the list of sidelink TCI states.

21. The method of claim 17, wherein the RRC signaling configures the list of sidelink TCI states for a physical sidelink shared channel (PSSCH).

22. The method of claim 21, wherein the RRC signaling indicates one or more of:
one or more sidelink TCI states to add to the list of sidelink TCI states configured for the PSSCH,
one or more sidelink TCI states to release from the list of sidelink TCI states configured for the PSSCH, or
one or more sidelink TCI states, corresponding to sidelink TCI states from among the list of sidelink TCI states configured for the PSSCH, to add to or release from a list of sidelink TCI states for one or more of a physical sidelink control channel or a physical sidelink feedback channel.

23. The method of claim 17, wherein the RRC signaling configures the list of sidelink TCI states using one or more of a physical sidelink shared channel configuration, a physical sidelink control channel configuration, or a physical sidelink feedback channel configuration included in a sidelink resource pool configuration.

24. The method of claim 17, wherein the list of sidelink TCI states configured in the RRC signaling includes a first set of sidelink TCI states that are configured for a physical sidelink shared channel (PSSCH) and a second set of sidelink TCI states that are configured for a physical sidelink control channel (PSCCH).

25. A method of wireless communication performed by a base station, comprising:
determining a list of sidelink transmission configuration indication (TCI) states to configure for a user equipment (UE); and
transmitting, to the UE, radio resource control (RRC) signaling configuring the list of sidelink TCI states.

26. The method of claim 25, wherein the list of sidelink TCI states includes a common TCI state pool for all sidelinks associated with the UE.

27. The method of claim 25, wherein the list of sidelink TCI states includes at least a first TCI state pool for a first sidelink associated with the UE and a second TCI state pool for a second sidelink associated with the UE.

28. The method of claim 25, wherein the RRC signaling indicates sidelink quasi co-location information associated with each sidelink TCI state included in the list of sidelink TCI states.

29. The method of claim 25, wherein the RRC signaling configures the list of sidelink TCI states using one or more of a physical sidelink shared channel configuration, a physical sidelink control channel configuration, or a physical sidelink feedback channel configuration included in a sidelink resource pool configuration.

30. The method of claim 25, wherein the list of sidelink TCI states configured in the RRC signaling includes a first set of sidelink TCI states that are configured for a physical sidelink shared channel (PSSCH) and a second set of sidelink TCI states that are configured for a physical sidelink control channel (PSCCH).
